(19) United States
(12) Patent Application Publication
(10) Pub. No.: US 2026/0299696 A1
(43) Pub. Date: Oct. 1, 2026

(54) HAPTIC WEARABLE DEVICES FOR TACTILE EXPERIENCES

(71) Applicant: Gwangju Institute of Science and Technology, Gwangju (KR)

(72) Inventors: Seung Jun KIM, Gwangju (KR); Seong Jun KANG, Gwangju (KR); Gwang Bin KIM, Gwangju (KR); Seok Hyun HWANG, Gwangju (KR); Jeong Ju PARK, Gwangju (KR); Ahmed Ibrahim Ahmed Mohamed Elsharkawy, Gwangju (KR)

(73) Assignee: Gwangju Institute of Science and Technology, Gwangju (KR)

(21) Appl. No.: 19/551,531

(22) Filed: Feb. 26, 2026

(30) Foreign Application Priority Data
Mar. 31, 2025 (KR) 10-2025-0041073

(51) Int. Cl. G06F 3/01; F03G 7/06

(52) U.S. Cl. CPC G06F 3/016; F03G 7/061; F03G 7/064

(57) ABSTRACT

The present disclosure relates to a haptic wearable device for tactile experiences, and more particularly, to a haptic wearable device that is operable in conjunction with an AR/VR environment and is configured to provide rapid temperature transitions corresponding to physical characteristics of a virtual material through thermal conversion and physical movement of a thermoelectric element, while simultaneously applying pressure to a user's skin by controlling a rotation speed and a rotation angle of the thermoelectric element, thereby providing a more delicate tactile experience to the user.

### CROSS REFERENCE TO PRIOR APPLICATIONS

This application claims priority to Korean Patent Application No. 10-2025-0041073 filed on Mar. 31, 2025, which is hereby incorporated by reference in its entirety.

### BACKGROUND OF THE INVENTION

The present disclosure relates to a haptic wearable device for providing tactile experiences, and more particularly, to a haptic wearable device that is operable in conjunction with an augmented reality (AR) and/or virtual reality (VR) environment, and is configured to provide rapid temperature transitions corresponding to physical characteristics of virtual materials through thermal conversion using a thermoelectric element and physical movement, while simultaneously applying pressure to a user's skin by controlling a rotation speed and an angle of the thermoelectric element, thereby providing a more delicate and realistic tactile experience to the user.

Recently, along with the rapid development of virtual reality (VR) and augmented reality (AR) technologies, various sensory-based feedback methods for maximizing user immersion have attracted significant attention. In particular, as the development of immersive content has been actively carried out, research and development of feedback technologies utilizing multiple senses beyond conventional visual- and auditory-centered user experience (UX) have been increasing.

In this regard, at the Consumer Electronics Show (CES) in 2016, virtual reality technology was selected as one of the promising future technologies, and various related products and technologies were introduced. Thereafter, with the release of Meta Quest 2 by Meta in 2020, an environment in which the general public could more easily access VR technology was established. Accordingly, research and development utilizing VR/AR technologies have been actively conducted in various application fields, including gaming, education, healthcare, and industry.

In this trend, haptic feedback technology has emerged as an important factor for further enhancing user immersion. In particular, research on haptic technologies including force feedback has been actively conducted, and related industries and research institutes have achieved technological advances in various haptic implementation methods. Currently, widely studied haptic feedback methods are mainly based on vibration actuators, which provide basic tactile stimuli in conjunction with user movements. However, such simple vibration-based feedback has limitations in providing a realistic immersive experience, and there is a growing demand for more sophisticated tactile stimuli, temperature variation, and force feedback technologies.

Accordingly, in order to implement an improved user experience, continuous technological development has been carried out for wearable devices that are attached to a user's body, or hand-held devices in the form of controllers. Such devices are evolving beyond simple vibration feedback toward providing more natural and immersive experiences by integrating various sensory modalities, and related research and technological innovation are continuously ongoing.

Therefore, there is a need for new tactile and force feedback technologies capable of providing a more realistic user experience in virtual reality environments, and various technical approaches for implementing such technologies are required.

For example, U.S. Patent Application Publication No. US2023/0050278 A1 relates to a wearable haptic and thermal feedback display system, which includes an array of vibrotactile actuators and thermal units attached to a flexible casing wearable around a forearm. According to this document, juxtaposed vibrotactile and thermal stimuli may enable richer haptic communication due to improved control over generated patterns, and the device may be wirelessly controlled using a smartphone, thereby demonstrating its applicability in long-distance haptic communication. However, since vibration-based feedback is provided instead of pressure feedback, realism during use is reduced, and because only a cross-sectional surface of the thermal element is utilized, there is a problem in that the temperature transition speed between heating and cooling is slow.

In addition, U.S. Pat. No. 11,181,984 B2 relates to a virtual reality input and haptic feedback system for sensing a user's hand movements. In this system, a haptic feedback device includes a variable surface configured to simulate softness or texture of a virtual surface, calculates an intensity and amplitude of feedback provided to each part of the user's hand based on input data, and controls fluid actuators and actuated valves such that an expandable member expands under increased pressure to maintain airtightness or contracts under reduced pressure, thereby causing a surface change of the haptic feedback device and providing tactile perception of surface texture and simulated pressure to the user's hand. However, this device has a limitation in that thermal feedback functionality is not included, thereby restricting sensory simulation related to heating and cooling sensations.

### SUMMARY OF THE INVENTION

In order to achieve the above-described objectives, the present disclosure provides a haptic wearable device for tactile experiences, comprising: a thermoelectric element including a heat absorption surface on one side and a heat generation surface on the other side; a servo motor connected to one end of the thermoelectric element and configured to rotate the thermoelectric element such that each surface of the thermoelectric element is selectively brought into contact with a user's skin; a control device connected to the thermoelectric element and the servo motor and configured to control a temperature, a rotation angle, and a rotation speed of the thermoelectric element; and a body fixing means configured to fix the thermoelectric element, the servo motor, and the control device to a user's body.

According to a preferred embodiment of the present disclosure, the thermoelectric element may be configured to control temperatures of the heat absorption surface and the heat generation surface within a range of 20° C. to 40° C., thereby providing a temperature-based tactile experience to the user.

According to a preferred embodiment of the present disclosure, the heat absorption surface and the heat generation surface of the thermoelectric element may further include an aluminum layer and a silicon layer.

According to a preferred embodiment of the present disclosure, a plurality of thermoelectric elements may be provided and arranged.

According to a preferred embodiment of the present disclosure, the thermoelectric elements may be arranged in two rows.

According to a preferred embodiment of the present disclosure, physical characteristics derived according to a virtual material to be represented through the thermoelectric element may be pre-input to the control device, and the control device may control the rotation speed and the rotation angle of the thermoelectric element according to the physical characteristics of the virtual material, thereby providing a tactile experience to the user.

According to a preferred embodiment of the present disclosure, the control device may be configured to simultaneously control temperature transition and rotational movement of the thermoelectric element.

According to a preferred embodiment of the present disclosure, the body fixing means may be provided in a strap form capable of fixing the device regardless of curvature of the user's body.

According to the present disclosure, the haptic wearable device for tactile experiences may be operable in conjunction with an AR/VR environment, and may provide rapid temperature transitions corresponding to physical characteristics of a virtual material through thermal conversion and physical movement of a thermoelectric element. In addition, by controlling the rotation speed and the rotation angle of the thermoelectric element to apply pressure to a user's skin, the haptic wearable device may provide a more delicate, realistic, and immersive tactile experience to the user.

### BRIEF DESCRIPTION OF THE DRAWINGS

FIG. 1 is a schematic view illustrating one surface of a haptic wearable device for tactile experiences according to a preferred embodiment of the present disclosure, as viewed from above.

FIG. 2 is a schematic view illustrating the other surface of the haptic wearable device for tactile experiences according to the preferred embodiment of the present disclosure, as viewed from above.

FIG. 3 is a schematic view illustrating an operation method of the haptic wearable device for tactile experiences according to the preferred embodiment of the present disclosure.

FIG. 4 is a schematic view illustrating another operation method of the haptic wearable device for tactile experiences according to the preferred embodiment of the present disclosure.

FIG. 5 is an image illustrating an overview in which the haptic wearable device for tactile experiences according to the preferred embodiment of the present disclosure operates in conjunction with an AR/VR virtual environment.

FIG. 6 is an image illustrating an example of use in which the haptic wearable device for tactile experiences according to the preferred embodiment of the present disclosure is used in conjunction with AR/VR.

FIG. 7 is an image illustrating another example of use in which the haptic wearable device for tactile experiences according to the preferred embodiment of the present disclosure is used in conjunction with AR/VR.

FIG. 8 is an image illustrating another example of use in which the haptic wearable device for tactile experiences according to the preferred embodiment of the present disclosure is used in conjunction with AR/VR.

FIG. 9 is an image illustrating another example of use in which the haptic wearable device for tactile experiences according to the preferred embodiment of the present disclosure is used in conjunction with AR/VR.

### DETAILED DESCRIPTION OF THE PREFERRED EMBODIMENTS

The terms used in the present disclosure are selected from general terms that are currently widely used where possible. However, in certain cases, terms arbitrarily selected by the applicant are also used. In such cases, the meanings of the terms should be understood based on the meanings described or used in the detailed description of the present disclosure, rather than the literal meanings of the terms themselves.

Hereinafter, the technical configuration of the present disclosure will be described in detail with reference to preferred embodiments illustrated in the accompanying drawings. However, the present disclosure is not limited to the embodiments described herein and may be embodied in various other forms. Throughout the specification, the same reference numerals denote the same components.

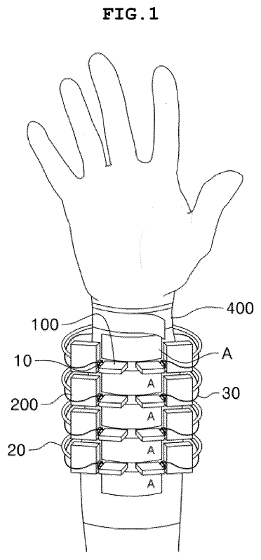

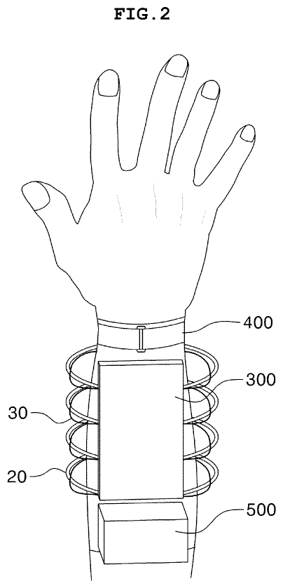

FIGS. 1 and 2 are schematic views illustrating one surface of a haptic wearable device for tactile experiences according to a preferred embodiment of the present disclosure, as viewed from above. The present disclosure relates to a haptic wearable device capable of providing tactile experiences by being worn on a user's body, such as a forearm, and operating in conjunction with an AR/VR virtual environment. As illustrated in FIGS. 1 and 2, the present disclosure provides a device capable of providing richer and more delicate tactile experiences by simultaneously applying pressure and thermal stimulation to a user's skin through a thermoelectric element in association with a virtual material contacted in an AR/VR virtual environment.

The present disclosure includes a thermoelectric element 100 having a heat absorption surface on one side and a heat generation surface on the other side. The thermoelectric element 100 may be a Peltier element, which exhibits characteristics in which, when electric current flows, one junction absorbs heat while the other junction generates heat due to the Peltier effect. Accordingly, the thermoelectric element 100 may cool one surface while releasing heat from the other surface, thereby including a heat absorption surface on one side and a heat generation surface on the other side.

The thermoelectric element 100 may be fixed in a standby state in a direction perpendicular to a user's skin. By rotating the thermoelectric element 100, both the heat absorption surface and the heat generation surface may be selectively brought into contact with the user's skin, thereby enabling rapid switching of temperature perceived through the user's skin. Through this configuration, the user may experience delicate and rich tactile sensations.

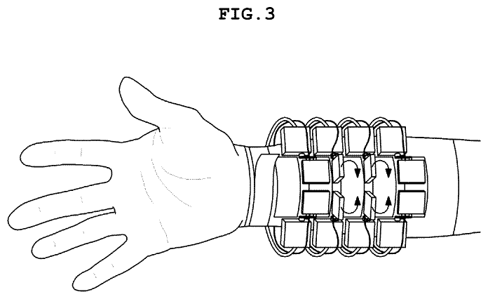

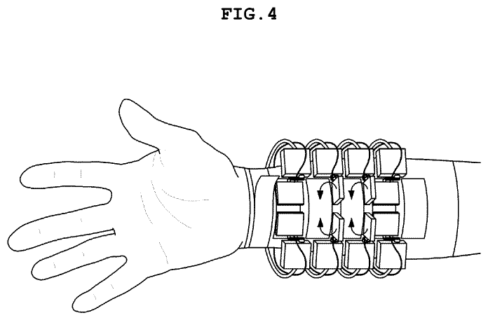

FIGS. 3 and 4 are schematic views illustrating an operation of the haptic wearable device for tactile experiences according to a preferred embodiment of the present disclosure. Specifically, FIG. 3 illustrates a state in which thermoelectric elements positioned in a first row and a fourth row of an array are rotated such that either the heat generation surface or the heat absorption surface is in contact with the user's skin, and FIG. 4 illustrates a state in which the thermoelectric elements positioned in the first row and the fourth row are rotated in an opposite direction such that either the heat generation surface or the heat absorption surface is in contact with the user's skin.

As illustrated in FIGS. 3 and 4, the present disclosure includes a servo motor 200 connected to one end of the thermoelectric element 100 by a thermoelectric element-servo motor connecting part 10, and configured to rotate the thermoelectric element 100 such that each surface of the thermoelectric element 100 may contact the user's skin. The servo motor 200 may rotate the thermoelectric element 100, which is in a standby state perpendicular to the skin, in a direction in which either the heat absorption surface contacts the user's skin or the heat generation surface contacts the user's skin.

In addition, the servo motor 200 enables rapid switching of the surface contacting the skin from the heat absorption surface to the heat generation surface, or from the heat generation surface to the heat absorption surface. Accordingly, compared to conventional devices using single-sided thermoelectric elements having a temperature change rate of approximately 1 to 4° C. per second, the present disclosure may expand the range of tactile experiences perceivable by the user.

For example, even when the heat absorption surface is operating at 20° C., the thermoelectric element may be rotated by the servo motor to switch to a heat generation surface at 40° C. within a few seconds. As a result, temperature changes that conventionally require 5 to 10 seconds or more may be experienced within a significantly shorter time, thereby expanding the tactile experience available to the user.

In this regard, any servo motor may be used as the servo motor 200 as long as it is capable of rotating the thermoelectric element fixed perpendicular to the skin in a standby state such that the heat absorption surface on one side and the heat generation surface on the other side may contact the skin, and the servo motor 200 is not limited to a specific type.

The servo motor 200 may rotate the thermoelectric element 100 within a range of 0° to 270°. By controlling the rotation direction, rotation angle, and rotation speed of the thermoelectric element 100 through the servo motor 200, the speed and angle at which the thermoelectric element contacts the skin may be adjusted, thereby varying a degree of pressure applied to the user's skin. Specifically, by adjusting a degree to which the skin is pressed by the thermoelectric element when contacting the skin in association with a virtual material, the user may be provided with a tactile experience capable of perceiving the virtual material presented in a virtual space.

For example, according to the present disclosure, by simultaneously switching temperature within a short period of time and controlling contact speed and stress applied to the skin, the user may experience rapidly changing virtual materials or abrupt changes in a virtual environment. Accordingly, the tactile experience available to the user may be significantly expanded compared to conventional devices.

According to the haptic wearable device for tactile experiences of the present disclosure, the thermoelectric element may be configured to control temperatures of the heat absorption surface and the heat generation surface within a range of 20° C. to 40° C., thereby providing a temperature-based tactile experience to a user. More preferably, a temperature range of the heat absorption surface may be from 20° C. to 28° C., and a temperature range of the heat generation surface may be from 31° C. to 40° C. When the temperature ranges of the heat absorption surface and the heat generation surface exceed the above-described range of 20° C. to 40° C., there may occur a problem in that excessive stimulation is applied to the user's skin.

In addition, the heat absorption surface and the heat generation surface of the thermoelectric element may further include an aluminum layer and a silicon layer. The aluminum layer and the silicon layer may be provided to stabilize temperature changes on surfaces of the heat absorption surface and the heat generation surface of the thermoelectric element. Preferably, the heat absorption surface may further include an aluminum layer on a surface thereof to assist heat absorption when the heat absorption surface contacts the user's skin, thereby helping the user experience a cold tactile sensation. In addition, the heat generation surface may further include a silicon layer on a surface thereof to prevent excessive heat generation at the heat generation surface, which may otherwise cause irritation to the user's skin and potential skin damage.

The present disclosure further includes a control device 300 connected to the thermoelectric element and the servo motor, and configured to control a temperature, a rotation angle, and a rotation speed of the thermoelectric element. In this regard, the servo motor and the control device may be connected by a servo motor-control device connecting part 20, and the thermoelectric element and the control device may be connected by a thermoelectric element-control device connecting part 30. Accordingly, the control device may be configured to simultaneously control temperature transition and rotational movement of the thermoelectric element.

More specifically, physical characteristics derived according to a virtual material to be represented through the thermoelectric element may be pre-input to the control device. The control device may control the rotation speed and the rotation angle of the thermoelectric element according to the physical characteristics of the virtual material, thereby providing a tactile experience to the user.

In this regard, the rotation speed and the rotation angle of the thermoelectric element may be calculated and applied according to Mathematical Expression 1 by using the physical characteristics of the virtual material pre-input to the control device.

$$\frac{d ε}{dt} = \frac{σ}{η} + \frac{1}{E} \frac{d σ}{dt} \qquad [ Mathematical Expression 1 ]$$

where ε represents strain according to stress of the material, η represents viscosity of the material, σ represents stress corresponding to the pressure applied to the user's skin when the material contacts the skin, and E represents Young's modulus of the material.

More specifically, Mathematical Expression 1 represents how a material contacting the skin is deformed in response to an external force. According to the expression, a tactile sensation perceived by the user's skin, such as whether the sensation feels soft or hard, may be adjusted by controlling stress and contact pressure.

In Mathematical Expression 1, a viscosity-related value η is predetermined contacting the skin. Accordingly, when the viscosity coefficient (η) is fixed, variables for adjusting an intensity of a material contacting the skin are stress (σ) and Young's modulus (E). Therefore, it is preferable to control the tactile experience such that a tactile sensation similar to a material contacted in a virtual environment (AR/VR) is provided by increasing stress to strongly press the skin, rotating the servo motor to switch a contact surface of the thermoelectric element having a different Young's modulus (E), or adjusting a speed at which pressure is applied.

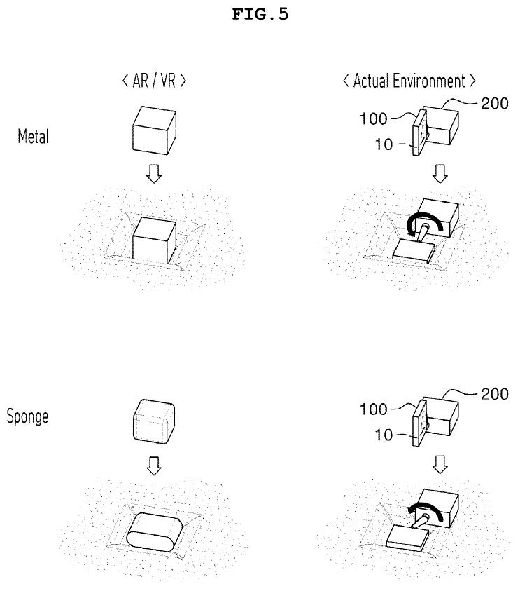

FIG. 5 is an image illustrating an overview in which the haptic wearable device for tactile experiences according to a preferred embodiment of the present disclosure operates in conjunction with an AR/VR virtual environment. As illustrated in FIG. 5, when a speed at which pressure is applied at a moment of contact with the skin and stress applied to the skin are derived based on values pre-input to the control device, it is preferable that, when a contact material in a virtual environment is metal, the material has higher rigidity than a sponge. Accordingly, it is preferable that the thermoelectric element has a higher stress value and a larger rotation angle than those used for a sponge.

Conversely, when the contact material in the virtual environment is a sponge, which has relatively lower rigidity than metal, it is preferable that the thermoelectric element has a smaller stress value and a smaller rotation angle than those used for metal.

As described above, by pre-inputting physical characteristics derived according to a virtual material to be represented to the control device, and controlling the rotation speed and the rotation angle of the thermoelectric element according to the corresponding material, the haptic wearable device may provide a more realistic and rich tactile experience to the user.

In the present disclosure, a plurality of thermoelectric elements may be provided and arranged. Preferably, the thermoelectric elements may be arranged in two rows, and more preferably, eight thermoelectric elements may be arranged in a 2×4 matrix. In this regard, the thermoelectric elements are not particularly limited as long as they are arranged in a manner capable of providing rich and delicate tactile experiences to a user. The plurality of thermoelectric elements may be operated in association with one another under control of the control device according to movement and rigidity of a virtual material, such that the thermoelectric elements may individually provide different tactile experiences on a surface of the user's skin.

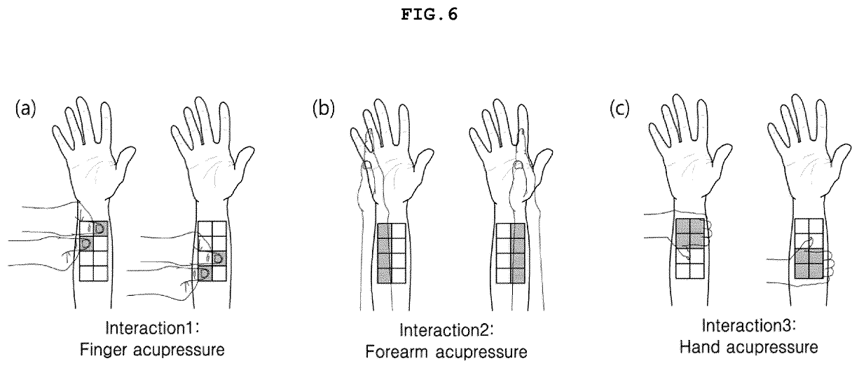

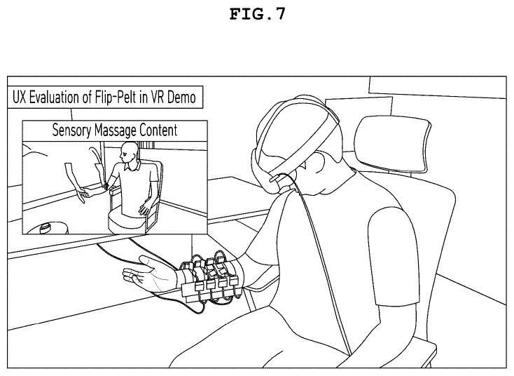

More specifically, this will be described with reference to FIGS. 6 and 7. FIGS. 6 and 7 are images illustrating examples of use in which the haptic wearable device for tactile experiences according to a preferred embodiment of the present disclosure operates in conjunction with AR/VR. More specifically, FIG. 6 illustrates a simulation image in which a tactile experience similar to receiving a massage is provided using the haptic wearable device according to a preferred embodiment of the present disclosure, in which a contact surface of a virtual masseur is synchronized with an operation range of the thermoelectric elements in conjunction with AR/VR. FIG. 7 illustrates an image showing a user experiencing a tactile sensation of receiving a massage.

As illustrated in FIG. 6, the haptic wearable device according to the present disclosure may provide a tactile experience similar to receiving a massage to a user. To this end, an image of a virtual masseur performing acupressure may be provided in a virtual environment, and thermoelectric elements corresponding to positions synchronized with massage locations of the masseur may be operated in association with one another. Each thermoelectric element may contact the user's skin while a temperature of the heat generation surface is adjusted to be similar to body temperature, and a contact speed and pressure applied to the user's forearm are controlled, thereby providing a tactile experience similar to hand massage.

For example, FIG. 6(a) illustrates an image in which acupressure is applied to a specific area of a user's wrist using fingers. In a virtual environment, a finger acupressure image is provided such that concentrated pressure is applied to a small area. Accordingly, in an actual situation, a plurality of thermoelectric elements corresponding to finger positions may repeatedly contact the skin with pressure and rotation speed similar to those of finger massage. In this case, the servo motor may be controlled by the control device such that one surface of each thermoelectric element corresponding to the finger positions repeatedly contacts the skin.

FIG. 6(b) illustrates an image in which pressure is applied over a wide area across the user's arm. In a virtual environment, an image is provided in which a masseur presses a large area of the user's arm using an arm, such that pressure is applied over a wider area. Accordingly, in an actual situation, a plurality of thermoelectric elements corresponding to an area of the masseur's arm may simultaneously contact the skin with pressure and rotation speed similar to those of palm massage. In this case, the servo motor may be controlled by the control device such that one surface of each thermoelectric element corresponding to positions pressed by the masseur's arm in the virtual environment repeatedly contacts the skin.

FIG. 6(c) illustrates an image in which pressure is applied over an area where a masseur wraps an entire hand around the user's arm. In a virtual environment, a palm acupressure image is provided such that pressure is applied over a relatively wide area. Accordingly, in an actual situation, a plurality of thermoelectric elements corresponding to a palm area may simultaneously contact the skin with pressure and rotation speed similar to those of palm massage. In this case, the servo motor may be controlled by the control device such that one surface of each thermoelectric element corresponding to palm positions repeatedly contacts the skin.

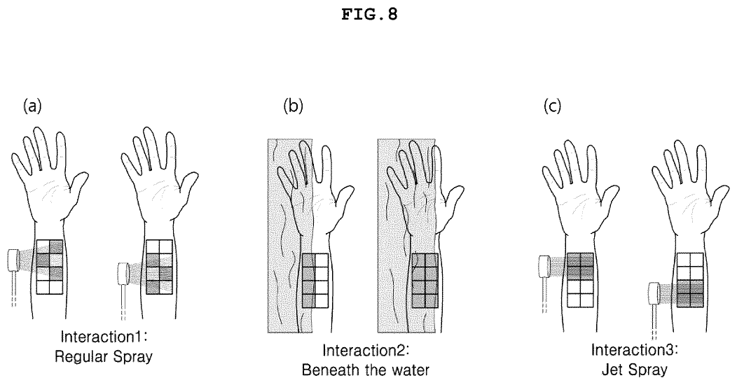

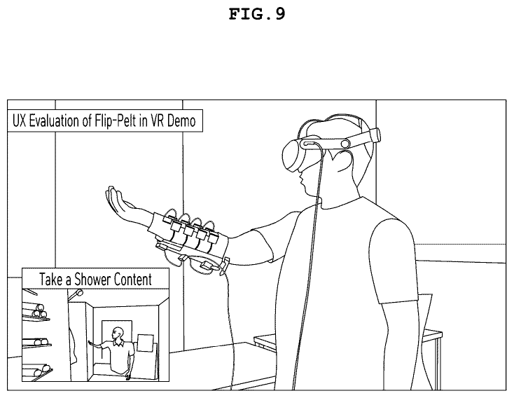

FIGS. 8 and 9 are images illustrating examples of use in which the haptic wearable device for tactile experiences according to a preferred embodiment of the present disclosure operates in conjunction with AR/VR. More specifically, FIG. 8 illustrates a simulation image in which a tactile experience similar to taking a shower is provided using the haptic wearable device according to a preferred embodiment of the present disclosure, in which a contact surface of a virtual shower and an operation range of thermoelectric elements are synchronized in conjunction with AR/VR. FIG. 9 illustrates an image showing a user experiencing a tactile sensation of taking a shower.

As illustrated in FIG. 8, the haptic wearable device according to the present disclosure may provide a tactile experience similar to an actual shower to a user. To this end, in a virtual environment, an image is provided in which water streams from a shower head and contacts the user's skin. In an actual environment, thermoelectric elements corresponding to positions where the water stream contacts the user's skin are operated in association with one another. Each of the plurality of thermoelectric elements operates to reproduce intensity and temperature experienced when shower water contacts the skin. That is, a temperature of the thermoelectric elements contacting the user's skin is adjusted to be similar to an actual water temperature, and movement and pressure applied by the thermoelectric elements to the user's forearm are also controlled, thereby implementing more a realistic tactile experience.

For example, FIG. 8(a) illustrates a method of reproducing a tactile sensation in which a strong water stream is concentrated at a specific location. When an image is provided in a virtual environment in which water from a shower head falls with strong pressure over a narrow area, the servo motor is controlled such that a plurality of thermoelectric elements corresponding to the location contact the skin with relatively high pressure and at a high speed. In addition, to reproduce a temperature sensation of the water stream, a temperature of the thermoelectric elements is adjusted to be similar to an actual water temperature. Through this configuration, the user may experience a vivid tactile sensation in which a strong water stream directly contacts the skin.

FIG. 8(b) illustrates a method of reproducing shower water that flows gently over a wide area. In a virtual environment, an image is provided in which water from a shower head spreads widely and flows around an entire arm of the user. In an actual environment, the servo motor is controlled such that a plurality of corresponding thermoelectric elements simultaneously contact the skin over a wide area. In this case, the thermoelectric elements gradually move in accordance with a flow speed of the water stream, and a temperature thereof is adjusted to be similar to an actual shower water temperature. Accordingly, the user may experience a tactile sensation as if wraps around and flows over the user's arm.

FIG. 8(c) illustrates a method of implementing a sensation in which shower water flows along the skin. In a virtual environment, an image is provided in which water flows smoothly along an arm while applying continuous pressure. In an actual environment, the servo motor is controlled such that a plurality of thermoelectric elements sequentially contact the skin along a corresponding path. In particular, the thermoelectric elements move organically in accordance with a flow of the water stream while adjusting applied pressure, thereby realistically reproducing a sensation of water flowing along the skin. In addition, a temperature of the thermoelectric elements is continuously adjusted, thereby also conveying changes in water temperature. Accordingly, the user may experience a natural tactile sensation of shower water flowing along the skin.

The present disclosure further includes a body fixing means 400 configured to fix the thermoelectric element, the servo motor, and the control device to a user's body. In this regard, the body fixing means may be provided in a strap form capable of fixing the device to the user's body regardless of a curvature of the user's body. However, the body fixing means is not limited thereto, and any structure capable of fixing the thermoelectric element, the servo motor, and the control device to the user's body may be used without limitation.

In addition, the present disclosure further includes a battery 500. The battery may be provided on one side of the body fixing means and may be connected to the thermoelectric element, the servo motor, and the control device to supply electrical energy thereto. Any type of battery may be used as long as it is capable of supplying electrical energy to the thermoelectric element, the servo motor, and the control device, and the battery is not particularly limited to a specific type.

As described above, the present disclosure has been illustrated and described with reference to preferred embodiments. However, the present disclosure is not limited to the above-described embodiments, and various modifications and variations may be made by those skilled in the art to which the present disclosure pertains without departing from the spirit and scope of the present disclosure.

### DESCRIPTION OF SYMBOLS

10: Thermoelectric element-servo motor connecting part
20: Servo motor-control device connecting part
30: Thermoelectric element-control device connecting part
100: Thermoelectric element
200: Servo motor
300: Control device
400: Body fixing means
500: Battery
A: User's skin not covered by the body fixing means

What is claimed is:

1. A haptic wearable device for tactile experiences, comprising:
a thermoelectric element including a heat absorption surface on one side and a heat generation surface on the other side;
a servo motor connected to one end of the thermoelectric element and configured to rotate the thermoelectric element such that each surface of the thermoelectric element is brought into contact with a user's skin;
a control device connected to the thermoelectric element and the servo motor and configured to control a temperature, a rotation angle, and a rotation speed of the thermoelectric element; and a body fixing means configured to fix the thermoelectric element, the servo motor, and the control device to a user's body.

2. The haptic wearable device of claim 1, wherein the thermoelectric element is configured to control temperatures of the heat absorption surface and the heat generation surface within a range of 20° C. to 40° C. to provide a temperature-based tactile experience to the user.

3. The haptic wearable device of claim 1, wherein the heat absorption surface and the heat generation surface of the thermoelectric element further include an aluminum layer and a silicon layer.

4. The haptic wearable device of claim 1, wherein a plurality of thermoelectric elements are provided and arranged.

5. The haptic wearable device of claim 4, wherein the thermoelectric elements are arranged in two rows.

6. The haptic wearable device of claim 1, wherein physical characteristics derived according to a virtual material to be represented through the thermoelectric element are pre-input to the control device, and the control device is configured to control the rotation speed and the rotation angle of the thermoelectric element according to the physical characteristics of the virtual material to provide a tactile experience to the user.

7. The haptic wearable device of claim 6, wherein the rotation speed and the rotation angle of the thermoelectric element are calculated and applied according to the following Mathematical Expression 1 by using the physical characteristics of the virtual material pre-input to the control device:
$$\frac{d ε}{dt} = \frac{σ}{η} + \frac{1}{E} \frac{d σ}{dt} \qquad [ Mathematical Expression 1 ]$$
where
ε represents strain according to stress of the material,
η represents viscosity of the material,
σ represents stress corresponding to the pressure applied to the user's skin when the material contacts the skin,
and E represents Young's modulus of the material.

8. The haptic wearable device of claim 1, wherein the control device is configured to simultaneously control temperature transition and rotational movement of the thermoelectric element.

9. The haptic wearable device of claim 1, wherein the body fixing means is provided in a strap form capable of fixing the device regardless of curvature of the user's body.
